(19) United States
(12) Patent Application Publication
(10) Pub. No.: US 2017/0316442 A1
(43) Pub. Date: Nov. 2, 2017

(54) INCREASE CHOICE SHARES WITH PERSONALIZED INCENTIVES USING SOCIAL MEDIA DATA

(71) Applicant: HRL Laboratories, LLC, Malibu, CA (US)

(72) Inventors: Kang-Yu Ni, Calabasas, CA (US); Tsai-Ching Lu, Thousand Oaks, CA (US); John Cafeo, Farmington, MI (US)

(21) Appl. No.: 15/429,125

(22) Filed: Feb. 9, 2017

Related U.S. Application Data
(60) Provisional application No. 62/293,310, filed on Feb. 9, 2016.

(51) Int. Cl. G06Q 30/02; G06Q 50/00

(52) U.S. Cl. CPC G06Q 30/0239; G06Q 30/0204; G06Q 30/0203; G06Q 50/01

(57) ABSTRACT

Described is a system for using social media data to supplement survey data for discrete choice analysis. Survey data from consumers is segmented into demographic groups. Individual demographic attributes and consumer product attribute preferences are extracted from a set of social media data. Consumer product attribute preferences are determined for each demographic group using the set of social media data. Consumers' preference coefficients are generated for each demographic group. Finally, individualized incentives for a target consumer product are determined using the consumers' preference coefficients.

### CROSS-REFERENCE TO RELATED APPLICATIONS

This is a Non-Provisional application of U.S. Provisional Patent Application No. 62/293,310, filed Feb. 9, 2016, entitled, “Increase Choice Shares with Personalized Incentives Using Social Media Data”, the entirety of which is incorporated herein by reference.

### BACKGROUND OF INVENTION

(1) Field of Invention

The present invention relates to a system for preference estimation for individuals and, more particularly, to a system for preference estimation for individuals using social media data.

(2) Description of Related Art

Choice modelling attempts to model the decision process of an individual or a group of individuals via revealed preferences or stated preferences made in a particular context. Discrete choice models analyze consumer choice behaviors and capture their preferences. A discrete choice model estimates the importance of each product attribute and how consumer profile affects the choices.

He et al. proposed an integrated choice model that considers social impact for forecasting new product adoption in “Incorporating social impact on new product adoption in choice modeling: A case study in green vehicles,” Transportation Research Part D: Transport and Environment 32 (2014): 421-434, which is hereby incorporated by reference as though fully set forth herein. They model integrated social network simulations at the individual consumer level into the discrete choice model. The authors demonstrated the benefits of considering social impact for green product adoption through a case study of hybrid electric vehicle owners in California. This is one of the first models that considered social networks, but only in terms of geo-location. Social media networks were not investigated in the work by He et al.

In “A Data-Driven Network Analysis Approach to Predicting Customer Choice Sets for Choice Modeling in Engineering Design,” Journal of Mechanical Design 137.7 (2015): 071410 (which is hereby incorporated by reference as though fully set forth herein), Wang and Chen proposed a network-based approach to predict customer choice sets. Their model created a product association network that reflects the similarity of two products in customers' preference space. Their model also accounted for customer heterogeneity by classifying them into clusters/segments based on their profile attributes. For each customer segment, the authors computed the product consideration frequency from the given data to predict the choice set. Additionally, they demonstrated that choice set prediction can improve the choice models, because the estimated individual choice probability heavily depends on the choice set composition. Social media data and social influence were not investigated in this work.

A similar work by Wang et al. in “A multidimensional network approach for modeling customer-product relations in engineering design,” Proceedings of the ASME 2015 International Design Engineering Technical Conferences & Computers and Information in Engineering Conference (IDETC/CIE 2015), which is hereby incorporated by reference as though fully set forth herein, used a multi-dimensional customer-product network framework that included a customer network besides a product network and customer-product relations. The customer network enabled exploration of social influence that may cause correlation of decisions and irrationality of customers. However, the network was built based on only geo-locations and demographic attributes, rather than actual social ties.

Furthermore, Langer explored the extent to which differences in demographic groups' preferences may lead to third degree differential pricing in “Demographic preferences and price discrimination in new vehicle sales,” University of Michigan, 2011, which is hereby incorporated by reference as though fully set forth herein. Langer estimated separate discrete choice models for married and unmarried men and women and calculates optimal markups for each group. In his findings, the observed price differences between demographic groups track the predicted relative markups with an effective rate between 30%-45%. Moreover, it was found that removing the ability to engage in third degree differential pricing would benefit one group and hurt another, and decrease producer surplus. However, this work was not extended to person-specific pricing and only utilized traditional survey data.

In “First Degree Price Discrimination Using Big Data,” Presented at The Federal Trade Commission, 2014 (which is hereby incorporated by reference as though fully set forth herein), Shiller investigated first degree differential pricing by using big data that tracks detailed individual behavior. Specifically, Shiller found that using demographics to personalize prices poorly predicts which consumers subscribe to Netflix, compared to using modern web-browsing data to estimate demand. However, there was only a single product in this differential pricing work.

Thus, a continuing need exists for a system that leverages social media to build actual online networks for discrete choice analysis.

### SUMMARY OF INVENTION

The present invention relates to a system for preference estimation for individuals and, more particularly, to a system for preference estimation for individuals using social media data. The system comprises one or more processors and a non-transitory computer-readable medium having executable instructions encoded thereon such that when executed, the one or more processors perform multiple operations. A set of survey data from consumers is segmented into demographic groups. Consumer product attribute preferences are extracted by tracking product mentions from inferred demographic groups using a set of social media data for a set of users. Consumer product attribute preferences for each demographic group are determined by adapting the survey data using the consumer product attribute preferences. Consumers' preference coefficients for each demographic group are determined, and individualized incentives for a target consumer product and the set of users are determined using the consumers' preference coefficients.

In another aspect, prior to determining the individualized incentive, a discrete choice model and differential pricing for the target consumer product are linked.

In another aspect, the discrete choice model is used to find a discounted price offer to make an individual consumer choose the specific consumer product alternative in a set of consumer product alternatives.

In another aspect, for a new consumer that is not represented by the set of survey data, the new consumer is assigned to a demographic group using the set of social media data, and preferences of the new consumer are inferred using a discrete choice model with the consumers' preference coefficients.

In another aspect, a choice utility Uᵢₖ of consumer i and consumer product alternative k is determined according to the following:

Uᵢₖ=Wᵢₖ+εᵢₖ,

where εᵢₖ represents an unobserved random disturbance, where Wᵢₖ is an observed utility which can be expressed as a linear combination of consumer product attributes xₖⱼ with consumer preference coefficients βᵢⱼ of consumer i and attribute j according to the following:

Wᵢₖ=Σⱼ₌₁^{J}βᵢⱼxₖⱼ.

In another aspect, a consumer preference coefficient of consumer i for attribute j is modeled as follows:

βᵢⱼ=β̅ⱼ+\tilde{β}ᵢⱼφᵢⱼ

where β̅ⱼ is a common coefficient within the demographic group, \tilde{β}ᵢⱼ>0 allows the degree of preference of individual i for attribute j, and φᵢⱼ is a known qualitative individual i's preference for attribute j.

In another aspect, an optimal discounted price offer is determined, and the system causes the optimal discounted price offer to be displayed to the user via their social media feed.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system for preference estimation according to some embodiments of the present disclosure;

FIG. 2 is an illustration of a computer program product according to some embodiments of the present disclosure;

FIG. 3 is a flow diagram illustrating the process flow of a system for preference estimation according to some embodiments of the present disclosure;

FIG. 4 is a table illustrating simulated discrete choice with product attributes, consumer profile attributes, and social influence attributes according to some embodiments of the present disclosure; and

FIG. 5 is a table illustrating improvement in predicting choice with social media data using the system according to some embodiments of the present disclosure.

### DETAILED DESCRIPTION

The present invention relates to a system for preference estimation for individuals and, more particularly, to a system for preference estimation for individuals using social media data. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of“step of” or “act of” in the claims herein is not intended to invoke the provisions of 35 U.S.C. 112, Paragraph 6.

(1) Principal Aspects

Various embodiments of the invention include three “principal” aspects. The first is a system for preference estimation. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

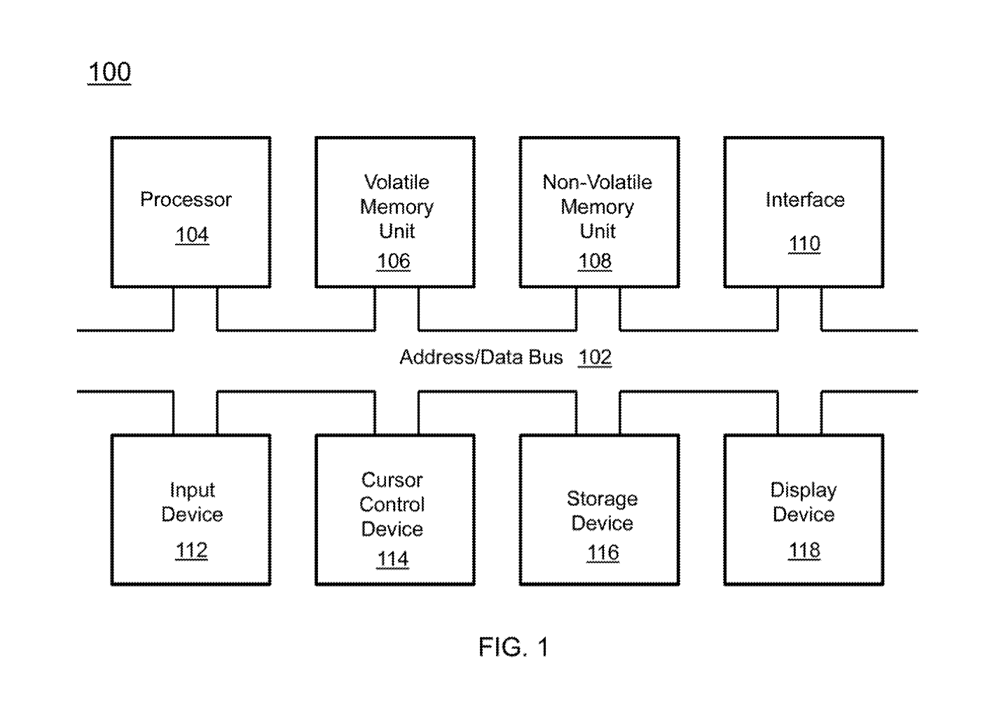

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

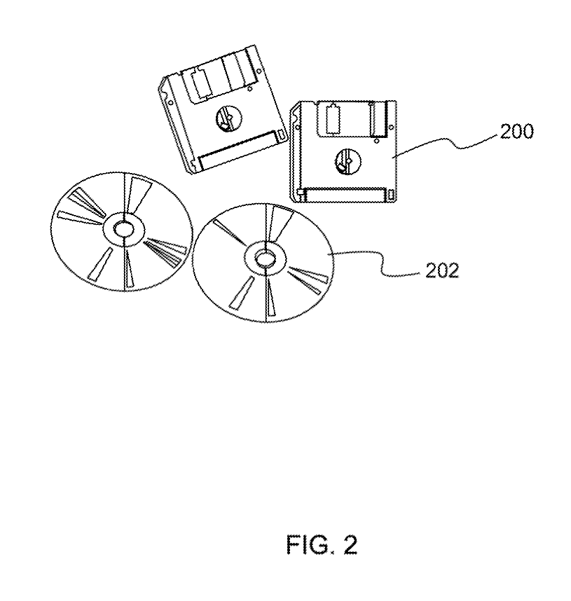

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of“instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

(2) Specific Details of Various Embodiments

Choice modelling attempts to model the decision process of an individual or a group of individuals via revealed preferences or stated preferences made in a particular context. Discrete choice models analyze consumer choice behaviors and capture their preferences. A discrete choice model estimates the importance of each product attribute and how consumer profile affects the choices. A challenge of incorporating social media into survey data for discrete choice analysis is the lack of mapping of the individuals and ground truth. The system according to embodiments of the present disclosure addresses the challenge by (1) linking discrete choice model and differential pricing and (2) providing a unique discrete choice model for heterogeneous preferences that incorporates social media data to increase the accuracy of discrete choice analysis.

As described above, social media data is used to supplement survey data for discrete choice analysis. The invention described herein leverages discrete choice analysis to find optimal price discounts for individual consumers in order to make a certain product in a choice set become the top choice. In addition, the discrete choice models can incorporate individual preferences harnessed from social media data and consider additional hidden social influence in consumer choice behaviors to further increase the accuracy of the model, which in turn increases the likelihood of product choice prediction.

Furthermore, the invention described herein enables first degree (personal/individualized) differential pricing in differentiated products by leveraging social media to infer and estimate unknown individual consumer preferences. Online social networks are utilized to infer choice preferences, because social impact has been found in new product adoption, as described by Lin et al. Moreover, homophily exhibits a significant feature in online social networks. Besides inferring product attribute preferences, unknown user demographic attributes are also inferred through online social networks, thereby discovering potential interested customers.

As described by Wang and Chen, a network-based model that predicts customer choice set increases accuracy in discrete choice analysis. However, in their work, the choice set prediction is at the consumer segment/cluster level (i.e., not at the individual level) and the demographic attributes are given. In contrast, the system according to embodiments of the present disclosure exploits online social networks to infer demographics, as well as capturing individual product attribute preferences, in order to enable first order differential pricing.

The system and method described herein enables timely demand and heterogeneous preference estimation and incentive design by harnessing social media data. Incorporating social media into a choice model will keep the model more contemporary, or up-to-date, and also reduce costs associated with design conjoint experiments. This will increase choice shares of a product by prescribing optimal personalized/individualized incentives (e.g., discounts). The method of differential pricing allows sellers to gain profits by offering optimal discounts that reflect customers' unique valuations that change with social influence, compared to group/regional differential pricing that may not be optimal. After determining an optimal discounted price offer, the system causes the optimal discounted price offer to be display to the user via their social media feed/updates. Non-limiting example of social media feeds/updates include Facebook® feed, Twitter® feed, Google® feed, Instagram® feed, YouTube® feed, Pinterest® feed, Vine® feed, and Tumblr® feed.

The goal of increasing choice shares by offering just enough incentives (i.e., minimal discount) in order to change customers' choices toward the target product and take the action to purchase requires more accurate discrete choice analysis that handles heterogeneous preferences. Here is a non-limiting example of a scenario: A customer is considering a set of vehicles to purchase. The set of vehicles have different features (i.e., differentiated products) that partially match the customer's preferences. In order to make a target product the top choice among the competitive products from customer's choice consideration set, the seller attempts to find out an optimal discounted price offer. The competitive products can be from other brands/companies or within the brand/company. In the latter case when the choice set consists of vehicles of the same brand, the strategy may involve selling the less popular vehicles. Another potential application scenario is to keep loyal customers by offering optimal incentives for trading in an old car and buying a new car to increase sales and increase customer arrival rates.

(2.1) Methodology

The model according to embodiments of the present disclosure extends the mixed logit models to model heterogeneous customer preferences of product attributes that do not follow certain distributions. Mixed logit allows unobserved factors to follow any distribution. The basic concept of mixed logit models are described in detail in D. Revelt and K. Train, “Mixed Logit with Repeated Choices of Appliance Efficiency Levels,” Review of Economics and Statistics, Vol. LXXX, No. 4, 647-657, 1998 (which is hereby incorporated by reference as though fully set forth herein). Below is a description of the improved mixed logit methodology according to embodiments of this disclosure that models customer preference of product attributes is provided below.

Inputs: Survey data (which contains purchased product (e.g., vehicle) and attributes, choice sets, consumer profile), social media data (e.g., Twitter, Facebook, Tumblr):
1. From the survey data, population is segmented into demographic groups according to attributes, such as gender, marital status, income, education level, etc.
2. From social media data, a) extract and infer individual demographic attributes (infer by label propagation); and b) find relevant contents about product attribute preferences/mentions, such as tweets and retweets that contain certain hashtags (vehicle manufacturers, vehicle models, desired product attributes, new vehicle purchases, asking for others' opinions on a set of choices). In social media data, an individual's demographic attributes (e.g., gender, age, ethnic group) are often unknown. However, these attributes can be inferred from other individuals whose attributes are publicly known. There are many existing label propagation methods that can infer individual demographic attributes, such as Raghavan, Usha Nandini, Réka Albert, and Soundar Kumara, “Near linear time algorithm to detect community structures in large-scale networks,” Physical review E 76.3 (2007): 036106, which is hereby incorporated by reference as though fully set forth herein.
3. For each demographic group (customer segment), determine attribute preference using the discrete choice model according to embodiments of the present disclosure that allows heterogeneous preference variance within the group where the individual specific preferences are captured from social media data.
   Outputs: Consumers' preference coefficients for each demographic group that are more accurate and less aggregated:
4. For a new customer who is not part of the population of the survey data, gather this customer's profile (including the use of social media) and find the appropriate demographic group that the new customer belongs to. Then, use the discrete choice model according to embodiments of the present disclosure with the estimated preference coefficients, together with any additional individual preference (if found or inferred from social media) to infer the customer's preference. Then, offer the optimal individualized incentives for a target product by lowering the price just enough to make the utility of that product the highest.

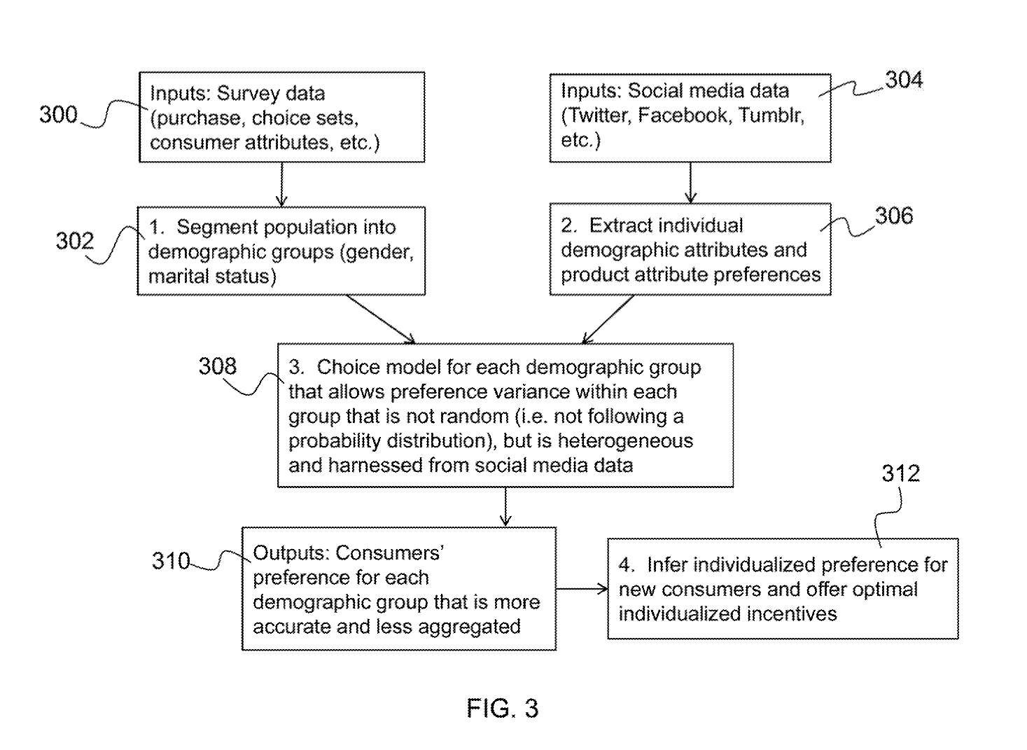

In one embodiment, it is assumed that the choice set (i.e., a set of choices that a consumer is considering) is known and the method described by Wang and Chen is used. Briefly, the method by Wang and Chen is a network approach for analyzing customer-product relations that considers product associations together with customer preference decisions. The method integrates product associations, customer social influence, and preference decisions as a network entity. This provides a choice set for each customer to allow better discrete choice analysis. In contrast to the method described by Wang and Chent, the system according to embodiments of the present disclosure exploits online social networks to infer demographics, as well as capturing individual product attribute preferences, in order to enable first order differential pricing. FIG. 3 illustrates the process flow of the method according to embodiments of the present disclosure. Survey data inputs 300 (e.g., purchase, choice sets, consumer attributes) are segmented into demographic groups (element 302), such as gender and marital status. Social media data inputs 304 (e.g., Twitter, Facebook, Tumblr) are processed in parallel to the survey data inputs 300 to extract individual demographic attributes and product attribute preferences (element 306). A choice model for each demographic group allows preference variance within each group that is not random (i.e., not following a probability distribution), but is heterogeneous and harnessed from social media data (element 308). The outputs 310 include consumers' preference for each demographic group that is more accurate and less aggregated. Finally, the system according to embodiments of the present disclosure infers individualized preference for new consumers and offers optimal individualized incentives.

Additional non-limiting examples of applications for the use of the invention described herein include using the choice model for choice share forecasts. Choice share forecasts predict the growth or decline of the choice shares of a product. Additionally, after detecting a Twitter user tweet about a recent new purchase (e.g., vehicle purchase), the system can be utilized to target the user's network friends and automatically generate or cause to be generated ads that pop up in the their browsers or internet feeds. Further, Twitter data can be employed to find desired vehicle attributes that are trending. Moreover, the system described herein can be used to find geo-location demands in order to determine the geo-location of stocks. For instance, a particular zip code needs more of a certain type of Chevrolet truck because of the rise of potential customers. In this way, when a customer is looking for a certain vehicle, it is available in the nearby dealers (but not in another state).

Further, geo-location browsing statistics can be used to determine locations the consumer frequently visits to narrow down where the consumer may purchase a product. In addition, an interactive customer inquiry Twitter account (e.g. SoCal Chevy On-Demand) can be set up such that customers can express their interests, and the system described herein can collect data.

(2.2) Discrete Choice Analysis that Models Heterogeneous Customer Preferences

After detecting that some Twitter user mentions are about a particular product (e.g., vehicles), the next step is to determine the user's preferences by inferring the user's demographics (if unknown) and product attribute preferences from his/her network neighbors. Social media data (e.g., Twitter data) is used to supplement survey data, as described above. Twitter users' preferences and demographics are identified and then related to one another to find evidence of social influence.

The choice utility of customer i and product alternative k is denoted by:

Uᵢₖ=Wᵢₖ+εᵢₖ,

where εᵢₖ represents an unobserved random disturbance, and where Wᵢₖ is the observed part of utility and can be expressed as a linear combination of the product attributes xₖⱼ with preference coefficients βᵢⱼ of customer i and attribute j according to the following:

Wᵢₖ=Σⱼ₌₁^{J}βᵢⱼxₖⱼ.

To accommodate heterogeneous preference within the group, the preference coefficient of individual i for attribute j is modeled as follows:

βᵢⱼ=β̅ⱼ+\tilde{β}ᵢⱼφᵢⱼ,

where β̅ⱼ is the common coefficient within the group, and φᵢⱼ describes the known qualitative individual i's preference for attribute j (heterogeneous preference within the group) as follows:

$${φ}_{ij} = \{ \begin{matrix}1 , & attribute j is highly desirable from individual i \\ - 1 , & attribute j is highly undesirable from individual i \\ 0 , & otherwise\end{matrix}$$

and \tilde{β}ᵢⱼ>0 allows the degree of preference of individual i for attribute j. This allows social media data to supplement survey data, which typically contains predefined questionnaires, such as individuals' demographics, choice set, chosen alternative, product attributes, and attribute preferences, but is not possible to be exhaustive. For example, certain specific desired product attributes (e.g., 4-wheel drive preference, needs to be compact) may be revealed by other means, such as social media data. The model according to this disclosure allows the additional information (which is biased) to be incorporated into the analysis.

The choice probability of the multinomial logit is:

$${P}_{ik} = \frac{{e}^{{W}_{ik}}}{{\sum }_{𝓁 = 1}^{K} {e}^{{W}_{i 𝓁}}} ,$$

where Pᵢₖ represents the probability of customer i choosing product k. A multinomial logit model is a model that predicts the probabilities of the different possible outcomes (i.e., multiple product alternatives) using logistic regression.

The preference coefficients of the model according to the embodiments of the present disclosure, βᵢⱼ are estimated by maximizing the log-likelihood function:

$$\begin{matrix}\hat{β} = {argmax}_{\overline{β}} {\sum }_{i = 1}^{N} {\sum }_{k = 1}^{K} {y}_{ik} log {P}_{ik} \\ = {argmax}_{\overline{β}} {\sum }_{i = 1}^{N} {\sum }_{k = 1}^{K} {y}_{ik} log ( \frac{{e}^{{\sum }_{j = 1}^{J} {β}_{ij} {x}_{kj}}}{{\sum }_{𝓁 = 1}^{K} {e}^{{\sum }_{j = 1}^{J} {β}_{𝓁 j} {x}_{kj}}} ) \\ = {argmax}_{\overline{β}} {\sum }_{i = 1}^{N} {\sum }_{k = 1}^{K} {y}_{ik} log [ \frac{{e}^{{\sum }_{j = 1}^{J} ( {\overline{β}}_{j} + {\tilde{β}}_{ij} {φ}_{ij} ) {x}_{kj}}}{{\sum }_{𝓁 = 1}^{K} {e}^{{\sum }_{j = 1}^{J} ( {\overline{β}}_{j} + {\tilde{β}}_{𝓁 j} {φ}_{ij} ) {x}_{kj}}} ] .\end{matrix}$$

The invention described herein is built on the mixed logit mode that, instead of assuming random taste (with a Gaussian distribution) for the different preferences coefficients for each consumer, describes the heterogeneous preference with the \tilde{β}ᵢⱼφᵢⱼ term. This individual consumer preference information is captured from social media data. The mixed logit model allows different preference coefficients for each consumer, but assumes random taste variation as follows:

$${W}_{ik} = {\sum }_{j = 1}^{J} {β}_{ij} {x}_{kj} , with {β}_{ij} ∼ f ( {β}_{j} \vert {θ}_{j} ) ,$$

where θⱼ are the parameters of the distribution of βⱼ over the population.

(2.3) Individualized Differential Pricing

The system described herein finds optimal incentives in order to make a target product the top choice of the customer, given a choice set with choice attributes, customer profile, and the estimated betas (i.e., correct βᵢⱼ) of the choice model. For example, the system identifies the price reduction (i.e., and resulting optimal discounted price offer) in order for the choice alternative to have the highest utility for the customer. This will also provide the choice probability. One can increase the discount until a desired probability is reached. Knowing the optimal discounted price offer can provide for many benefits to the system operator. For example, the optimal discounted price offer can be displayed to the customer in their internet browser or other online feeds, such as through their social media accounts, etc.

(2.4) Experimental Studies

The likelihood ratio index, defined as:

$$ρ = 1 - \frac{LL ( \hat{β} )}{LL ( 0 )} ,$$

measures how well the estimated preference coefficients can predict choice. The likelihood ratio index is bounded by 0≦ρ≦1, where ρ=0 means the estimated coefficients do not predict better than random predictions, and ρ=1 means that predictions can be made perfectly.

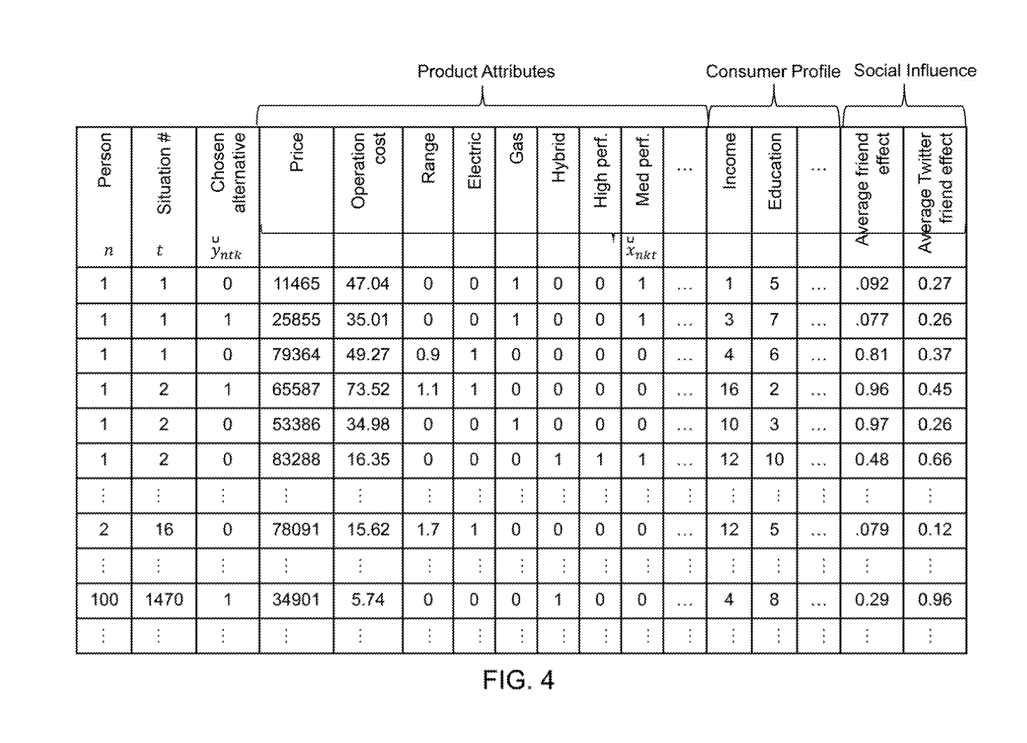

Below is a description of simulations that demonstrate that social influence from a social media network can increase the likelihood ratio index. The table in FIG. 4 shows simulated discrete choice data with product attributes, consumer profile attributes, and social influence attributes.

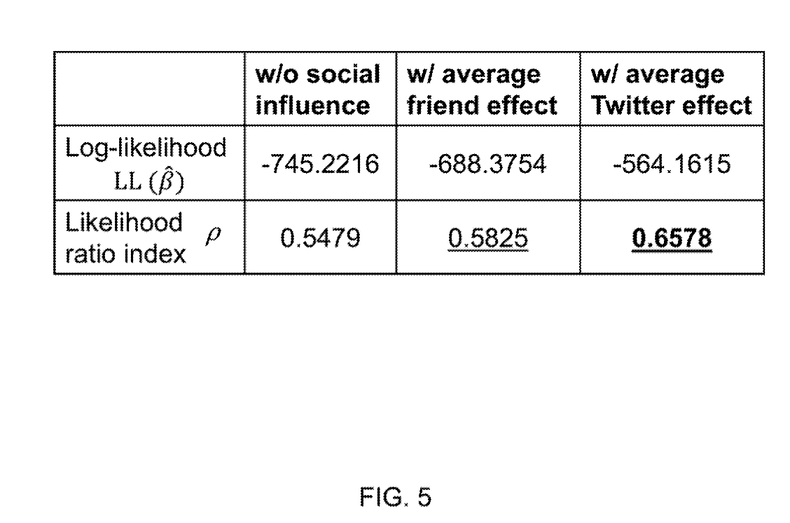

The table in FIG. 5 shows the log-likelihood LL(\hat{β}) and likelihood ratio index ρ for analysis without social influence, with average friend effect (i.e., the strength of social ties through friendship), and with average friend effect and Twitter effect (i.e., the strength of social times in Twitter), respectively. With Twitter effect, an additional 14% improvement in predicting choice with social media data is gained.

As a non-limiting example, the system described herein can provide personalized incentives that will increase the likelihood of interested consumers purchasing certain products, such as vehicles. For example, a customer is considering a set of vehicles to purchase. The set of vehicles have different features (i.e., differentiated products) that partially match the customer's preferences. In order to make a target product the top choice (among the competitive products from customer's choice consideration set), the seller attempts to find out an optimal discounted price offer.

A potential commercial application of the present invention is a method to increase sale numbers/shares of vehicles for a particular manufacturer with personalized incentives that will increase the likelihood of interested consumers purchasing vehicles from that manufacturer. The competitive products can be from other brands/companies or within the brand/company. In the latter case when the choice set consists of vehicles of the same brand, the strategy may involve selling the less popular vehicles. Another potential application scenario is to keep loyal customers by offering optimal incentives for trading in old car and buying new car to increase sales (increase customer arrival rate). Another potential application is to use the product attributes of the choice model to support product designs and increase the attractiveness of vehicles.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for heterogeneous consumer preference estimation, the system comprising:
one or more processors and a non-transitory computer-readable medium having executable instructions encoded thereon such that when executed, the one or more processors perform operations of:
segmenting a set of survey data from consumers into demographic groups;
extracting consumer product attribute preferences by tracking product mentions from inferred demographic groups using a set of social media data for a set of users;
determining consumer product attribute preferences for each demographic group by adapting the survey data using the consumer product attribute preferences;
generating consumers' preference coefficients for each demographic group; and
determining individualized incentives for a target consumer product and the set of users using the consumers' preference coefficients.

2. The system as set forth in claim 1, wherein the one or more processors further perform an operation of, prior to determining the individualized incentive, linking a discrete choice model and differential pricing for the target consumer product.

3. The system as set forth in claim 2, wherein the one or more processors further perform an operation of using the discrete choice model to find a discounted price offer to make an individual consumer choose the specific consumer product alternative in a set of consumer product alternatives.

4. The system as set forth in claim 1, wherein for a new consumer that is not represented by the set of survey data, the one or more processors further perform operations of:
assigning the new consumer to a demographic group using the set of social media data; and
inferring preferences of the new consumer using a discrete choice model with the consumers' preference coefficients.

5. The system as set forth in claim 1, wherein the one or more processors further perform an operation of determining a choice utility Uᵢₖ of consumer i and consumer product alternative k according to the following:
Uᵢₖ=Wᵢₖ+εᵢₖ,
where εᵢₖ represents an unobserved random disturbance, where Wᵢₖ is an observed utility which can be expressed as a linear combination of consumer product attributes xₖⱼ with consumer preference coefficients βᵢⱼ of consumer i and attribute j according to the following:
Wᵢₖ=Σⱼ₌₁^{J}βᵢⱼxₖⱼ.

6. The system as set forth in claim 5, wherein a consumer preference coefficient of consumer i for attribute j is modeled as follows:
βᵢⱼ=β̅ⱼ+\tilde{β}ᵢⱼφᵢⱼ
where β̅ⱼ is a common coefficient within the demographic group, \tilde{β}ᵢⱼ>0 allows the degree of preference of individual i for attribute j, and φᵢⱼ is a known qualitative individual i's preference for attribute j.

7. The system as set forth in claim 1, wherein the one or more processors further perform operations of:
determining an optimal discounted price offer; and
causing the optimal discounted price offer to be displayed to the user via their social media feed.

8. A computer implemented method for heterogeneous consumer preference estimation, the method comprising an act of:
causing one or more processers to execute instructions encoded on a non-transitory computer-readable medium, such that upon execution, the one or more processors perform operations of:
segmenting a set of survey data from consumers into demographic groups;
extracting consumer product attribute preferences by tracking product mentions from inferred demographic groups using a set of social media data for a set of users;
determining consumer product attribute preferences for each demographic group by adapting the survey data using the consumer product attribute preferences;
generating consumers' preference coefficients for each demographic group; and
determining individualized incentives for a target consumer product and the set of users using the consumers' preference coefficients.

9. The method as set forth in claim 8, wherein the one or more processors further perform an operation of prior to determining the individualized incentive, linking a discrete choice model and differential pricing for the target consumer product.

10. The method as set forth in claim 9, wherein the one or more processors further perform an operation of using the discrete choice model to find a discounted price offer to make an individual consumer choose the specific consumer product alternative in a set of consumer product alternatives.

11. The method as set forth in claim 8, wherein for a new consumer that is not represented by the set of survey data, the one or more processors further perform operations of:
assigning the new consumer to a demographic group using the set of social media data; and
inferring preferences of the new consumer using a discrete choice model with the consumers' preference coefficients.

12. The method as set forth in claim 8, wherein the one or more processors further perform an operation of determining a choice utility Uᵢₖ of consumer i and consumer product alternative k according to the following:
Uᵢₖ=Wᵢₖ+εᵢₖ,
where εᵢₖ represents an unobserved random disturbance, where Wᵢₖ is an observed utility which can be expressed as a linear combination of consumer product attributes xₖⱼ with consumer preference coefficients βᵢⱼ of consumer i and attribute j according to the following:
Wᵢₖ=Σⱼ₌₁^{J}βᵢⱼxₖⱼ.

13. The method as set forth in claim 12, wherein a consumer preference coefficient of consumer i for attribute j is modeled as follows:
βᵢⱼ=β̅ⱼ+\tilde{β}ᵢⱼφᵢⱼ
where β̅ⱼ is a common coefficient within the demographic group, \tilde{β}ᵢⱼ>0 allows the degree of preference of individual i for attribute j, and φᵢⱼ is a known qualitative individual i's preference for attribute j.

14. The method as set forth in claim 8, wherein the one or more processors further perform operations of:
determining an optimal discounted price offer; and
causing the optimal discounted price offer to be displayed to the user via their social media feed.

15. A computer program product for heterogeneous consumer preference estimation, the computer program product comprising:
computer-readable instructions stored on a non-transitory computer-readable medium that are executable by a computer having one or more processors for causing the processor to perform operations of:
segmenting a set of survey data from consumers into demographic groups;
extracting consumer product attribute preferences by tracking product mentions from inferred demographic groups using a set of social media data for a set of users;
determining consumer product attribute preferences for each demographic group by adapting the survey data using the consumer product attribute preferences;
generating consumers' preference coefficients for each demographic group; and
determining individualized incentives for a target consumer product and the set of users using the consumers' preference coefficients.

16. The computer program product as set forth in claim 15, further comprising instructions for causing the one or more processors to perform an operation of prior to determining the individualized incentive, linking a discrete choice model and differential pricing for the target consumer product.

17. The computer program product as set forth in claim 16, further comprising instructions for causing the one or more processors to perform an operation of using the discrete choice model to find a discounted price offer to make an individual consumer choose the specific consumer product alternative in a set of consumer product alternatives.

18. The computer program product as set forth in claim 15, wherein for a new consumer that is not represented by the set of survey data, the computer program product further comprises instructions for causing the one or more processors to further perform operations of:
assigning the new consumer to a demographic group using the set of social media data; and
inferring preferences of the new consumer using a discrete choice model with the consumers' preference coefficients.

19. The computer program product as set forth in claim 15, further comprising instructions for causing the one or more processors to further perform an operation of determining a choice utility Uᵢₖ of consumer i and consumer product alternative k according to the following:
Uᵢₖ=Wᵢₖ+εᵢₖ,
where εᵢₖ represents an unobserved random disturbance, where Wᵢₖ is an observed utility which can be expressed as a linear combination of consumer product attributes xₖⱼ with consumer preference coefficients βᵢⱼ of consumer i and attribute j according to the following:
Wᵢₖ=Σⱼ₌₁^{J}βᵢⱼxₖⱼ.

20. The computer program product as set forth in claim 19, wherein a consumer preference coefficient of consumer i for attribute j is modeled as follows:
βᵢⱼ=β̅ⱼ+\tilde{β}ᵢⱼφᵢⱼ
where β̅ⱼ is a common coefficient within the demographic group, \tilde{β}ᵢⱼ>0 allows the degree of preference of individual i for attribute j, and φᵢⱼ is a known qualitative individual i's preference for attribute j.

21. The computer program product as set forth in claim 15, further comprising instructions for causing the one or more processors to further perform operations of:
determining an optimal discounted price offer; and
causing the optimal discounted price offer to be displayed to the user via their social media feed.
